(19) United States
(12) Patent Application Publication
(10) Pub. No.: US 2011/0085875 A1
(43) Pub. Date: Apr. 14, 2011

(54) FASTENING ASSEMBLY AND METHOD

(75) Inventor: Jeffrey M. Aftanas, Ortonville, MI (US)

(73) Assignee: JAC-Rack, Inc., Pontiac, MI (US)

(21) Appl. No.: 12/903,799

(22) Filed: Oct. 13, 2010

Related U.S. Application Data
(60) Provisional application No. 61/250,895, filed on Oct. 13, 2009.

(51) Int. Cl. F16B 5/06

(52) U.S. Cl. 411/347

(57) ABSTRACT

A fastening system especially well suited for use with solar panel systems that enables an electrical connection to be made between two metallic frame components that are secured together. The fastening assembly includes a spring clip and a threaded bolt that engages within a hole in the spring clip. The spring clip has a leaf spring like shape. The threaded bolt has a head portion shaped to permit it to be inserted in a channel of a frame member, then rotated ninety degrees, which flattens the spring clip and enables it to retain the threaded bolt in an upright orientation ready for use. After being rotated ninety degrees, the head is retained in the channel as well. The fastening assembly can be inserted into a suitable sized channel of a frame member at any point along the channel, thus significantly simplifying and expediting the assembly of solar panel modules onto a supporting frame element.

### CROSS-REFERENCE TO RELATED APPLICATIONS

This application claims the benefit of U.S. Provisional Application No. 61/250,895 filed on Oct. 13, 2009. The disclosure of the above application is incorporated herein by reference.

### TECHNICAL FIELD

The present disclosure relates to electrical grounding devices and methods, and more particularly to an electrical grounding device and method that enables positive electrical contact to be made between electrically conductive panels or components.

### BACKGROUND

In various applications, especially when connecting solar panel modules to a supporting frame structure, there is a need to make a ground connection between the metal frame of the module and the metal material of the supporting frame when the module is secured to the frame. Various types of metal washers have been proposed, with each having various limitations.

In many applications, especially those involving the assembly of solar panel modules onto ground surface or a roof top, the need to be able to assemble the modules to a frame structure quickly, efficiently, and without the need for special tools, is also a major consideration.

### BRIEF DESCRIPTION OF THE DRAWINGS

FIG. 1 is a side view of one embodiment of the fastening assembly of the present disclosure;

FIG. 2 is a side view of the spring panel of the assembly of FIG. 1 but with a spring clip and a fastening member of the fastening assembly both rotated 90 degrees from the orientation shown in FIG. 1;

FIG. 3 is a perspective view of the fastening assembly;

FIG. 4 is a plan view of the spring clip with the threaded bolt removed;

FIG. 5 is an end view of just the spring clip of the fastening assembly;

FIG. 6 shows a first operation in using the fastening assembly to secure a frame portion of a solar panel module to a frame member, wherein a head portion of a fastening member of the assembly is orientated in a channel of the frame member;

FIG. 7 shows the head portion pushed down and rotated 90 degrees to hold the spring clip, as well as the fastening member being used with a separate nut to secure the frame portion of the solar panel module to the frame member so that the spring clip ensures electrical contact between the frame portion and the frame member;

FIG. 8 shows an another embodiment of the spring clip used to form the fastening assembly of FIG. 1;

FIG. 9 shows still another embodiment of the spring clip that may be used to form the fastening assembly of FIG. 1;

FIG. 10 shows still another embodiment of the spring clip that may be used to form the fastening assembly of FIG. 1;

FIG. 11 shows a top perspective view of another embodiment of the spring clip; and

FIG. 12 shows a bottom perspective view of the spring clip of FIG. 11.

### DETAILED DESCRIPTION

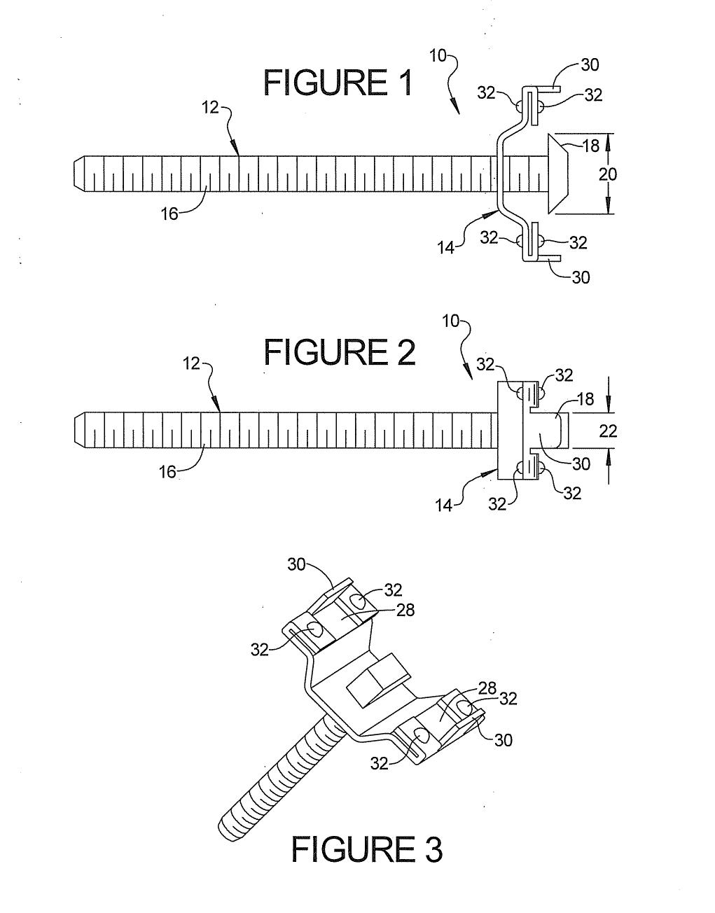

Referring to FIGS. 1 and 2, there is shown a fastening assembly 10 in accordance with one embodiment of the present disclosure. The fastening assembly 10 generally includes a threaded bolt 12 and a spring clip 14. The threaded bolt 12 has a threaded shaft 16 and a head portion 18. The head portion 18 has a first dimension, noted by arrow 20 in FIG. 1, that is longer than a second dimension 22, as indicated in FIG. 2. In one application, the length of the threaded shaft 16 is sufficient to extend through the thickness of a frame portion of a solar panel module so that the fastening assembly 10 can be used to secure a solar panel module to a frame member. However, it will be appreciated that the length and overall dimensions of both the threaded bolt 12 and the spring clip 14 will need to be adjusted to meet the requirements of the specific application at hand. The threaded bolt 12 may be made from any suitable metal or other material.

Referring to FIGS. 1 and 3-5, the spring clip 14 can be seen in greater detail. The spring clip 14 is preferably made from a resilient material, for example spring steel, although other materials having a degree of flexibility or resiliency may be employed. The spring clip 14 has a leaf-spring like shape that defines a central portion 24 with a hole 26, and opposing end portions 28. The opposing end portions 28 each are formed by a folded over section of material, as best visible in FIGS. 1 and 3, and each includes a generally perpendicularly extending tab 30 as seen in FIG. 3. On each opposing end portion 28 is a projecting tooth 32 that may be formed by simply partially punching out a small portion of material from the opposing end portions 28 before the portions 28 are folded over onto one another. This way when the opposing end portions 28 are folded over to take the shape as shown in FIG. 3, the projecting teeth 32 will be projecting in opposing directions. This feature is shown particularly well in FIG. 5. The tabs 30 may have a width, as defined by arrow 34 in FIG. 5, that allows the tab to rest in a channel of a frame member, as will be explained further in the following paragraphs.

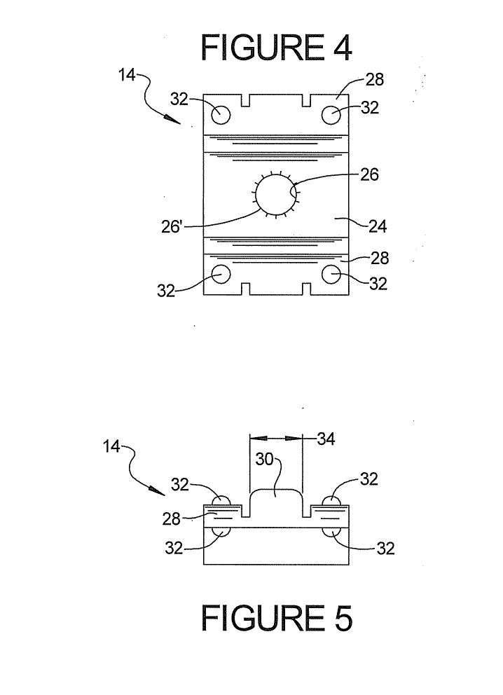

The hole 26 (FIG. 4) preferably also has a plurality of radial cuts or slots 26′ that enables the threaded shaft 16 of the bolt 12 to be more easily threaded into and through the spring clip 14 and retained therein. For the solar panel application mentioned herein, the diameter of the threaded shaft 16 will also preferably be selected so that the threaded shaft 16 can extend through a channel formed in the frame member of the solar panel module.

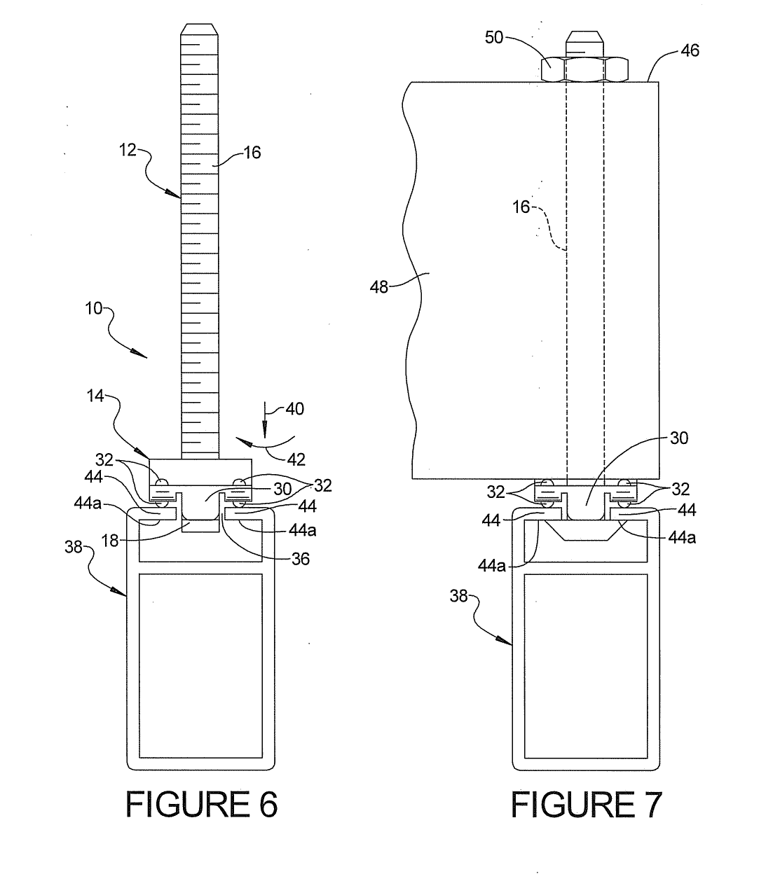

Referring now to FIGS. 6 and 7, the use of the fastening assembly 10 in securing a solar panel module to a frame member will be described. In FIG. 6 the fastening assembly is first placed with the head portion 18 of the threaded bolt 12 in a channel 36 of a frame member 38. The head portion 18 is oriented so that its narrower dimension (defined by arrow 22 in FIG. 2) can be extended part way into the channel 36. The user then grasps the threaded shaft 16 and pushes in a downward direction in accordance with arrow 40 with sufficient force to flatten the spring clip 14. While the spring clip 14 is held in its flattened orientation, the user rotates the threaded shaft 16 in accordance with directional arrow 42 so that the head portion 18 is turned about 90 degrees into the orientation shown in FIG. 7. When the user releases the threaded shaft 16, the spring clip 14 maintains the head portion 18 against the inside surfaces 44a of shoulder portions 44 of the frame member 38, as shown in FIG. 7. The length of the head portion 18, as defined by arrow 20 in FIG. 1, is such that once the head portion 18 is turned to the position shown in FIG. 7 it is captured in the channel 36 and cannot be removed therefrom.

The user may thereafter adjust the longitudinal positioning of the fastening assembly 10 along the length of the frame member 38, if needed, by pressing down on the threaded shaft 16, rotating the head portion 18 back into the position shown in FIG. 6, sliding the fastening assembly 10 to the desired position, and then rotating the head portion 18 back into the position shown in FIG. 7 and then releasing the threaded shaft 16.

FIG. 7 illustrates the threaded shaft 16 of the threaded bolt 12 having been inserted through a suitable opening in a frame portion 46 of a solar panel module 48. Once nut 50 is tightened down, the teeth 32 are able to dig or “bite” into the metallic surfaces of the frame member 38 and the frame portion 46, and form an electrically conductive grounding path through the spring clip 14. Typically the frame member 38 will be coupled to ground via a suitable cable. Thus, the fastening assembly 10 not only functions to provide a quick and easy to use mechanism for securing the solar panel 48 to the frame member 38, but also a mechanism for automatically creating an electrically conductive path between the two frame components 46 and 38.

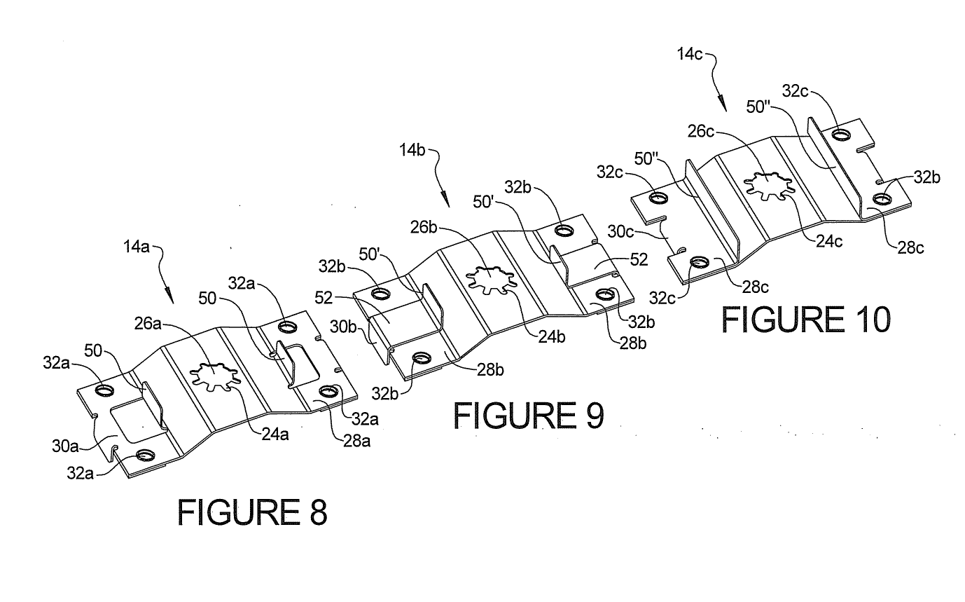

FIG. 8 shows a spring clip 14a that forms another embodiment of the spring clip 14. The spring clip 14a is somewhat similar in construction to the spring clip 14 and includes a central portion 24a having an opening 26a, and opposing end portions 28a. The opening 26a engages the threaded shaft 16 of the bolt 12. The opposing end portions 28a each include oppositely projecting pairs of teeth 32a and tabs 30a for maintaining the spring clip 14a centered along the longitudinal centerline of the frame member 38. Spring clip 14a otherwise operates in the same fashion as described for the spring clip 14. However, the spring clip 14a includes tabs 50 formed from punched out sections of the opposing end portions 28a. The tabs 50 serve to provide stop members that define a predetermined spacing between two adjacently positioned ones of the solar panel modules 48 when the two adjacent solar panel modules 48 are abutted against the tabs 50 while being secured to the frame member 38. Thus, the spring clip 14a not only functions to provide an excellent grounding path between the solar panel modules(s) 48 and the frame member 38, but also functions to maintain the spacing between adjacent modules 48 in accordance with a predetermined, desired spacing.

Referring to FIG. 9 a spring clip 14b is illustrated in accordance with another embodiment of the spring clip 14. The spring clip 14b similarly includes a central portion 24b having an opening 26b, opposing end portions 28b, and opposing pairs of teeth 32b. However, a length of material 52 extends from each of the opposing end portions 28b and is partially folded over on itself to form two tabs 30b and 50′. The tabs 30b (only one being visible in FIG. 9) serve to maintain the spring clip 14b centered along the channel 36 of the frame component 38, while the tabs 50′ act as stop members to maintain a predetermined spacing between adjacently positioned solar panel modules 48.

Referring to FIG. 10, a spring clip 14c in accordance with still another embodiment of the spring clip 14 is shown. The spring clip 14c similarly includes a central portion 24c having an opening 26c, and opposing end portions 28c. The opposing end portions 28c each have two pairs of oppositely projecting teeth 32c projecting therefrom. However, the opposing end portions 28c are formed from folded over sections of material that each include tabs 30c (only one being visible in FIG. 10) for centering the spring clip 14c along the channel 36 of the frame member 38, as well as a folded distal edge that forms an upwardly projecting tab 50″. The upwardly projecting tabs 50″ in this instance extend the full width of the central portion 24c and serve to act as stop members to maintain a predetermined spacing between two adjacently positioned solar panel modules 48.

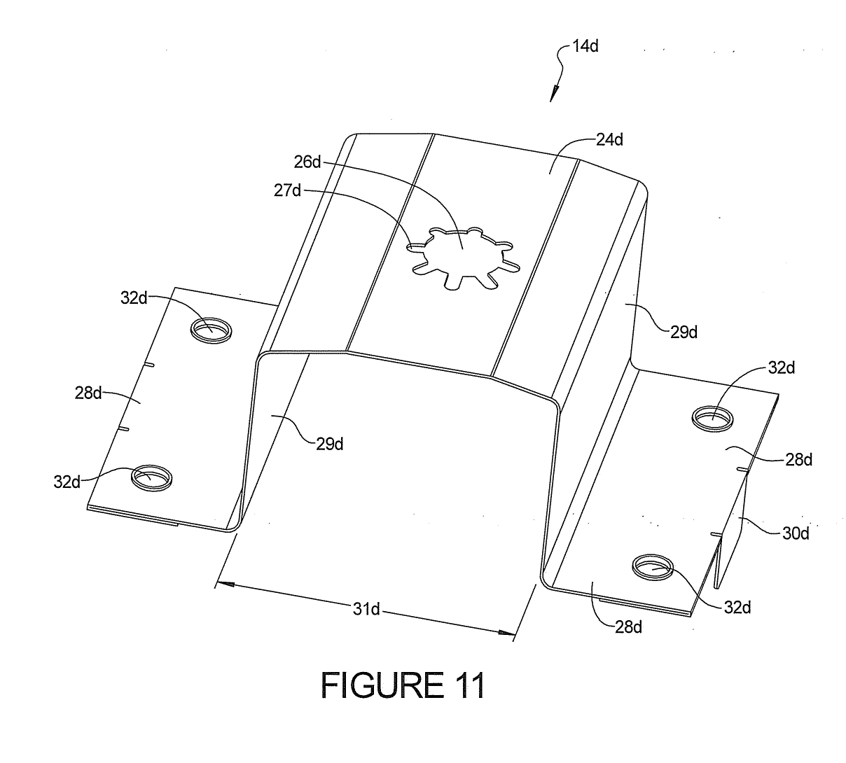

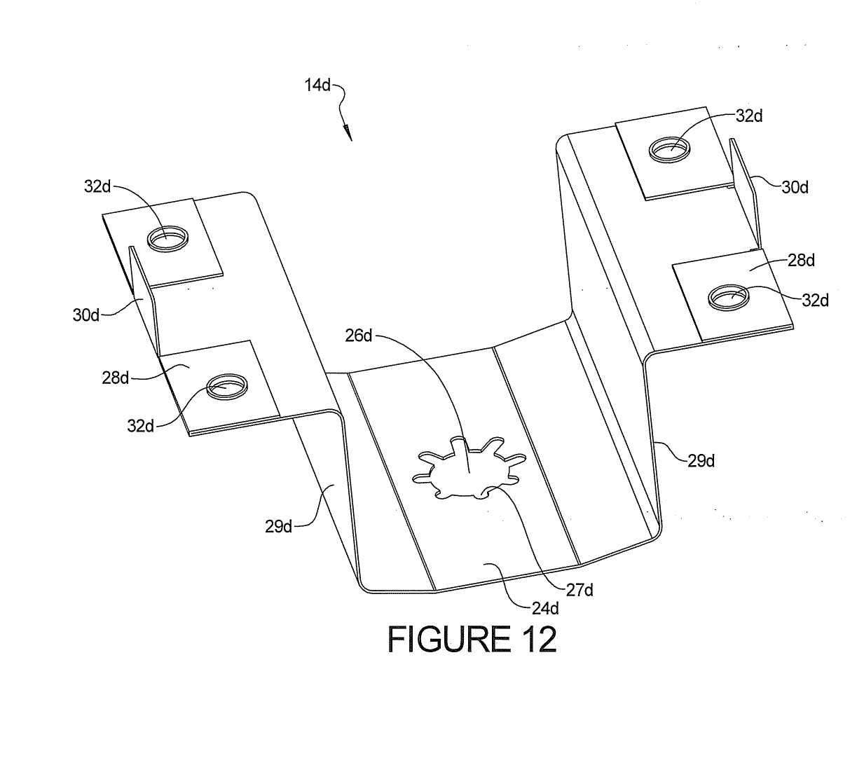

Referring to FIGS. 11 and 12, there is shown a spring clip 14d in accordance with yet another embodiment of the present application. The spring clip 14d is also made from a metallic material that has good electrical conductivity properties and is resistant to corrosion from the elements, for example stainless steel. The spring clip 14d may include a central portion 24d having an opening 26d with a plurality of radially arranged slots 27d. Side portions 29d extend generally perpendicularly from the central portion 24d and have a predetermined spacing, defined by arrow 31d. The spacing defined by arrow 31d controls the spacing between two adjacent solar panel modules 48 that are positioned to abut the side portions 29d when positioned on the frame member 38.

Opposing end portions 28d of the spring clip 14d are formed from folded over sections of material and project in opposite directions from the central portion 24d. Opposing end portions 28d may each include an integrally formed tab 30d and a plurality of pairs of oppositely projecting teeth 32d. Tabs 30d rest in the channel 36 (FIG. 6) when the spring clip 14d is positioned on the frame member 38 and maintain the spring clip 14d aligned with the longitudinal axis of the frame member 38 during the assembly process. Teeth 32d may be punched out before folding over the material that helps form the opposing edge portions 28d, thus forming a plurality of pairs of aligned teeth that project in opposite directions from the opposing end portions 28d. The spring clip 14d otherwise operates in the same fashion as the spring clips 14, 14a, 14b and 14c to form a means for providing an electrically conductive path between the solar panel module 48 and the frame member 38 once the module 48 is secured to the frame member 38, and also to maintain the desired spacing between adjacently positioned modules 48.

The ability of the fastening assembly 10 to hold the threaded bolt 12 in an upright manner within the channel 36 of the frame member is a significant benefit. Often the frame member 38 is several feet long, and often may be four foot, eight foot, or even longer in overall length. The ability of the user to position the fastening assembly 10 at a desired, approximate point along the length of the frame member 38 is a significant advantage in reducing the assembly time required for the user to install a solar panel system. Often such systems may involve several, or possibly dozens or even hundreds of independent solar panel modules that must be installed on a plurality of frame members with suitable grounding washers or like implements being used with the fasteners that are used to fasten the modules to their respective frame members. With previously developed grounding implements adapted to fit in a channel of a frame member, the grounding implement often needs to be inserted at one end of the channel and then slid to the approximate longitudinal point along the channel where it will be fastened. This can take considerable time, especially in installations where dozens or hundreds of solar panel modules are being installed. The construction of the fastening assembly 10 of the present disclosure enables it to be inserted directly into the channel at the approximate point where the user anticipates it will be fastened to the frame member 38, thus eliminating the need to install it from one open end of the channel. Advantageously, the spring clip 14, 14a, 14b or 14c operates to maintain the entire assembly at the desired location while the frame member is being handled and the solar panel module 48 secured thereto.

While the fastening assembly 10 has been described as being well suited for use in the assembly of solar panel systems, it will be appreciated that the fastening assembly is also expected to find utility in a wide variety of other applications as well. The fastening system 10 may be used in virtually any application where two components need to be secured together, and an electrically conductive path formed between them as the securing operation is completed.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A fastening system comprising:
a spring clip having a leaf spring-like shape and a hole:
a threaded bolt having a threaded shaft and an enlarged head portion;
the threaded shaft adapted to engage within the hole in the spring clip, the enlarged head portion adapted to fit within a channel of a frame member, then rotated a predetermined degree, which captures the enlarged head portion within the channel while a user is grasping the threaded shaft portion and applying a force directed toward the channel; and
the spring clip operating to bias and hold the threaded shaft portion in an upright orientation perpendicular to the frame member when the user releases the force being applied to the threaded shaft.

2. The fastening system of claim 1, wherein the spring clip includes two opposing end portions each having a folded section of material forming a tab, the tabs each having a width just slightly less than the channel of the frame member so that the tabs serve to align the spring clip with the channel when the spring clip is positioned on the channel of the frame member and the tabs are engaged with the channel.

3. The fastening system of claim 1, wherein the spring clip has a pair of opposing end portions, with each said opposing end portion having a plurality of projecting tooth portions adapted to bite into a surface of the channel and a surface of a metallic member being secured to the frame member.

4. The fastening system of claim 3, wherein each of the projecting tooth portions are formed from punched out portions of folded over sections of material of the spring clip.

5. The fastening system of claim 2, wherein the projecting tooth portions form pairs of projecting tooth portions that project in opposite directions.

6. The fastening system of claim 1, further comprising a pair of tabs that project outwardly from the spring clip, the tabs having a spacing selected to maintain with a desired predetermined spacing of two adjacent photovoltaic panels positioned adjacent to the spring clip.

7. The fastening system of claim 1, wherein the spring clip is made from spring steel.

8. A fastening system comprising:
a metallic spring clip having a leaf spring-like shape, a hole in a central portion thereof, and a pair of opposing end portions each having a plurality of tooth portions projecting in opposite directions:
a threaded bolt having a threaded shaft and an enlarged head portion;
the threaded shaft adapted to engage within the hole in the spring clip, the enlarged head portion adapted to fit within a channel of a frame member, then rotated a predetermined degree, which captures the enlarged head portion within the channel while a user is grasping the threaded shaft portion and applying a force directed toward the channel to flatten the spring clip; and
the spring clip operating to bias and hold the threaded shaft portion in an upright orientation perpendicular to the frame member when the user releases the force being applied to the threaded shaft.

9. The fastening assembly of claim 8, wherein the spring clip includes a projecting tab at each said opposing end portion, the projecting tabs each having a width adapted to enable them to be inserted into the channel to prevent the spring slip from rotating relative to the channel.

10. The fastening assembly of claim 8, wherein the spring clip includes:
a first pair of projecting tabs adapted to reside within the channel of the frame member, to prevent rotation of the spring clip relative to the frame member when the spring clip is fastened to the frame member; and
a second pair of tabs projecting in a direction opposite to the first pair of tabs, the second pair of tabs having a spacing selected to maintain a desired spacing of two adjacent photovoltaic panels being secured by the fastening assembly to the frame member.

11. The fastening assembly of claim 8, wherein the spring clip is made from spring steel.

12. The fastening assembly of claim 8, wherein the opposing end portions include folded over sections of material, and wherein the projecting teeth are formed from punched out sections of the folded over sections of material.

13. The fastening assembly of claim 8, wherein the enlarged head portion has a width smaller than a width of an opening of the channel into which the enlarged head portion is inserted, and wherein the enlarged head portion has a length that is longer that a width of an interior cross section of the channel.

14. The fastening assembly of claim 8, wherein the leaf spring-like shape of the spring clip includes a pair of side portions that extend generally perpendicularly from the central portion of the spring clip, the side portions having a selected spacing that separates a pair of photovoltaic panels by a predetermined, desired distance when the pair of photovoltaic panels is secured to the frame member using the fastening system.

15. A fastening system comprising:
a spring clip having a leaf spring-like shape, a hole at a central portion thereof, and a pair of opposing end portions, the pair of opposing end portions each including folded over sections each having a pair of projecting tooth portions that project in opposite directions:
a threaded bolt having a threaded shaft and an enlarged head portion;
the threaded shaft adapted to engage within the hole in the spring clip, the enlarged head portion adapted to fit within a channel of a frame member, then rotated a predetermined degree that is less than ninety degrees, which captures the enlarged head portion within the channel while a user is grasping the threaded shaft portion and applying a force directed toward the channel; and
the spring clip operating to bias and hold the threaded shaft portion in an upright orientation perpendicular to the frame member when the user releases the force being applied to the threaded shaft; and
the projecting tooth portions each adapted to bite into a respective surface of the frame member and a metallic portion of a component associated with a photovoltaic panel being secured by the fastening assembly to the frame member.

16. The fastening system of claim 15, wherein the spring clip includes a first pair of tabs adapted to extend into the channel when the spring clip is positioned on the frame member over the channel, the first pair of tabs operating to prevent rotation of the spring clip as a threaded nut is secured to the threaded shaft when securing a component of a photovoltaic panel to the frame member.

17. The fastening system of claim 16, wherein the spring clip includes a second pair of tabs projecting in a direction opposite to the first pair of tabs, the second pair of tabs having a spacing adapted to space apart a pair of photovoltaic panels, that are secured to the frame member by the fastening system, a predetermined distance.

18. The fastening system of claim 15, wherein the central portion of the spring clip includes a pair of side portions formed to extend parallel to one another, the side portions having a spacing adapted to separate a pair of photovoltaic panels secured to the frame member by the fastening system by a predetermined distance.

19. The fastening system of claim 15, wherein the spring clip is formed from spring steel.

20. The fastening system of claim 15, wherein the spring clip is formed from a single piece of spring steel.
